(19) United States
(12) Patent Application Publication
(10) Pub. No.: US 2026/0045667 A1
(43) Pub. Date: Feb. 12, 2026

(54) INSULATION TAPING DEVICE FOR SECONDARY BATTERY AND INSULATION TAPING METHOD FOR SECONDARY BATTERY

(71) Applicant: SAMSUNG SDI CO., LTD., Yongin-si (KR)

(72) Inventors: MYUNGHWAN SEO, Yongin-si (KR); Jiho YANG, Yongin-si (KR); Jushik UHM, Yongin-si (KR); Daeseong JEONG, Yongin-si (KR)

(21) Appl. No.: 19/212,920

(22) Filed: May 20, 2025

(30) Foreign Application Priority Data
Aug. 6, 2024 (KR) 10-2024-0104333

(51) Int. Cl. H01M 50/595; H01M 10/04; H01M 50/586

(52) U.S. Cl. CPC H01M 50/595; H01M 10/0404; H01M 50/586

(57) ABSTRACT

An insulation taping device for a secondary battery includes a jelly roll case, into which a jelly roll with a tape attached to a top surface of the jelly roll is to be introduced, an insertion jig including a through-hole and positioned above the jelly roll case, the insertion jig being configured to be coupled to a bottom end of a can, and the through-hole being configured to be coupled to a top end of the jelly roll case to guide the jelly roll, and a driver configured to drive the jelly roll case into the insertion jig, the tape on the top surface of the jelly roll contacting the insertion jig and adhering to a side surface of the jelly roll as the jelly roll is inserted into the can in the insertion jig.

### CROSS REFERENCE TO RELATED APPLICATION

This application claims priority under 35 U.S. C § 119 to Korean Patent Application No. 10-2024-0104333, filed in the Korean Intellectual Property Office on Aug. 6, 2024, the entire contents of which are hereby incorporated by reference.

### BACKGROUND

### 1. Field

The present disclosure relates to an insulation taping device for a secondary battery and an insulation taping method for a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In a case where an internal short occurs in a secondary battery due to electrical contact between two materials having different polarities, the temperature of the secondary battery may increase rapidly and, in severe cases, may lead to a fire. To prevent two materials having different polarities from coming into electrical contact inside the secondary battery, the secondary battery may contain components related to insulation.

Secondary batteries may be categorized into, e.g., coin batteries, cylindrical batteries, prismatic batteries, and pouch batteries depending on the shape of the battery case. In a secondary battery, the electrode assembly mounted inside the battery case is a chargeable and dischargeable power generator including a stacked structure of a positive electrode, a separator, and a negative electrode. Electrode assemblies may be roughly categorized as a jelly roll type, which is a wound structure of sheet-shaped positive and negative electrodes and a separator provided between the positive and negative electrodes, a stack type, which is a stacked structure of a plurality of positive electrodes, a plurality of negative electrodes, and a separator provided therebetween, and a stack/folding type in which stack type unit cells are wound with elongated separator films.

Among the above, the jelly roll electrode assemblies are widely used because the jelly roll electrode assemblies are easy to manufacture and have a high energy density per weight. Cylindrical secondary batteries are manufactured by inserting a jelly roll electrode assembly into a cylindrical can and capping the resulting structure with a cover cap.

The above information disclosed in this Background section is for enhancement of understanding of the background of the present disclosure, and therefore, it may contain information that does not constitute related (or prior) art.

### SUMMARY

Aspects of embodiments provide an insulation taping device for a secondary battery including a jelly roll case into which a jelly roll with tape attached to a top surface thereof may be introduced; an insertion jig coupled to a bottom end of a can and configured to include a through-hole coupled to a top end of the jelly roll case to guide the jelly roll; and a driver configured to drive the jelly roll case upward, the tape contacts the insertion jig and adheres to a side surface of the jelly roll as the jelly roll may be inserted into the can.

According to an embodiment, the insertion jig may include a base provided on an inner surface of the through-hole; a tapered portion provided on the inner surface of the through-hole at a bottom end of the base; a first stepped portion provided on the inner surface of the through-hole at a bottom end of the tapered portion, and coupled to the top end of the jelly roll case; and a second stepped portion provided on the inner surface of the through-hole at a top end of the tapered portion, and coupled to the can.

According to an embodiment, the tapered portion may be configured such that a radial size thereof decreases from the first stepped portion to the base.

According to an embodiment, the diameter of the first stepped portion corresponds to the outer diameter of the jelly roll case.

According to an embodiment, a step of the first stepped portion may be smaller than the thickness of the jelly roll case.

According to an embodiment, the inner diameter of the jelly roll case corresponds to the inner diameter of inner diameter.

According to an embodiment, the diameter of the second stepped portion corresponds to the outer diameter of the can.

According to an embodiment, a step of the second stepped portion corresponds to the thickness of the can.

According to an embodiment, the first stepped portion may be configured such that a terminal end of the jelly roll case may be inserted thereinto.

According to an embodiment, the inner diameter of the base corresponds to the jelly roll to which the tape may be adhered.

According to an embodiment, an outer peripheral portion of the tape may be circumferentially adhered to an outer surface of the jelly roll as the tape contacts an inner circumferential surface of the base due to upward movement of the jelly roll.

According to an embodiment, the tapered portion may be tapered at the bottom end of the base by a difference between a maximum thickness and a minimum thickness of the jelly roll case.

According to an embodiment, the second stepped portion may be configured such that a terminal end of the can may be inserted thereinto.

Aspects of embodiments further provide a method for manufacturing an insulation taping method for a secondary battery, the method including: attaching tape to a top surface of a jelly roll; moving, by a driver, a jelly roll case upward into which a jelly roll may be inserted; coupling an insertion jig to the jelly roll case, the insertion jig having a through-hole configured to guide the jelly roll; and compressing the tape to an upper portion of the jelly roll as the jelly roll may be inserted into a can to which the insertion jig may be coupled.

According to an embodiment, may further include inserting the jelly roll up to a terminal end of the can.

According to an embodiment, the operation of moving the jelly roll case upward may include introducing the jelly roll, to which the tape may be attached, into an opened top surface of the jelly roll case.

According to an embodiment, in the coupling of the insertion jig to the jelly roll case, a terminal end of the jelly roll case may be inserted into a first stepped portion provided on an inner surface of the through-hole.

According to an embodiment, the coupling of the insertion jig to the jelly roll case may include bending an outer peripheral portion of the tape by contact with a tapered portion provided on an inner surface of the through-hole.

According to an embodiment, in the compressing of the tape, in a case where the jelly roll may be moved upward to be inserted into the can, the outer peripheral portion of the tape circumferentially adheres to an outer surface of the jelly roll.

According to an embodiment, in the inserting of the jelly roll, the jelly roll, which is insulated by the tape on the top surface, may be moved upward without interference with an inner circumferential surface of the can.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a cross-sectional view showing an insulation taping device for a secondary battery according to embodiments of the present disclosure.

FIG. 2 illustrates a cross-sectional view showing an insertion jig according to embodiments of the present disclosure.

FIG. 3 illustrates a jelly roll with an upper portion to which tape used in the insulation taping device for a secondary battery according to embodiments of the present disclosure is attached.

FIG. 4A illustrates a cross-sectional view showing the jelly roll of FIG. 3 introduced into the insulation taping device for a secondary battery according to embodiments of the present disclosure.

FIG. 4B illustrates an enlarged view showing region A of FIG. 4A.

FIG. 4C illustrates an enlarged view showing region B of FIG. 4A.

FIG. 4D illustrates an enlarged view showing region A in which the jelly roll and the tape are omitted.

FIG. 5 illustrates a jelly roll inserted up to the terminal end of a can coupled to the insertion jig according to embodiments of the present disclosure.

FIG. 6 illustrates a flowchart showing an insulation taping method for a secondary battery according to embodiments of the present disclosure.

FIG. 7 illustrates a flowchart showing an insulation taping method for a secondary battery in which a jelly roll inserting operation is added according to embodiments of the present disclosure.

FIG. 8 illustrates a process of the insulation taping method for a secondary battery according to embodiments of the present disclosure.

FIG. 9 illustrates a process of the insulation taping method for a secondary battery according to embodiments of the present disclosure, following the process of FIG. 8.

FIG. 10A illustrates a process of the insulation taping method for a secondary battery according to embodiments of the present disclosure, following the process of FIG. 9.

FIG. 10B illustrates an enlarged view showing area C of FIG. 10A.

FIG. 11A illustrates a process of the insulation taping method for a secondary battery according to embodiments of the present disclosure, following the process of FIG. 10A.

FIG. 11B illustrates an enlarged view showing area D of FIG. 11A.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S. C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used herein are intended to describe embodiments of the present disclosure and are not intended to limit the present disclosure.

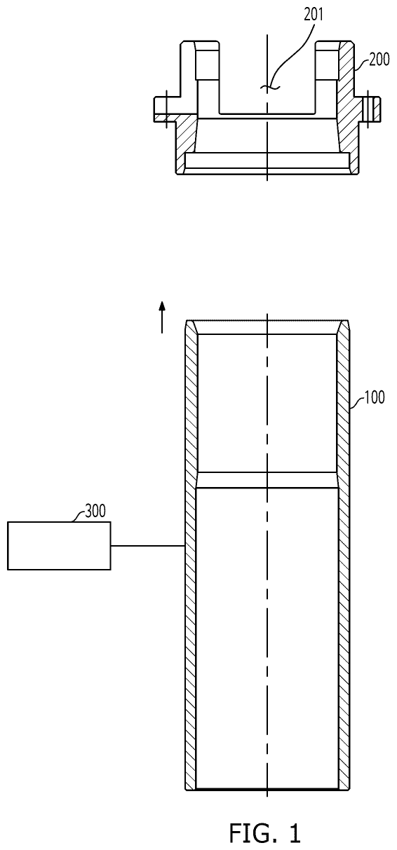

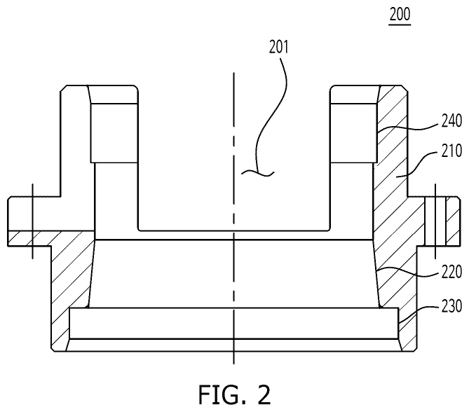

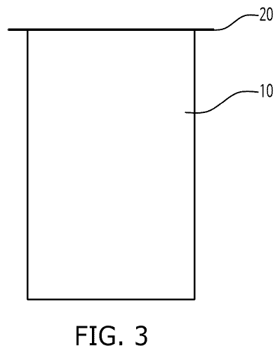

FIG. 1 illustrates a cross-sectional view showing an insulation taping device for a secondary battery according to embodiments of the present disclosure, FIG. 2 illustrates a cross-sectional view showing an insertion jig according to embodiments of the present disclosure, and FIG. 3 illustrates a jelly roll with the upper portion to which tape used in the insulation taping device for a secondary battery according to embodiments of the present disclosure is attached.

Referring to FIG. 1, an insulation taping device for a secondary battery according to embodiments of the present disclosure may include a jelly roll case 100, an insertion jig 200, and a driver 300. FIG. 1 illustrates a cross-sectional view showing a structure in which the jelly roll case 100 is cut in the height direction along a line crossing the center of the roughly cylindrical jelly roll case 100.

Referring to FIGS. 1 and 3, a jelly roll 10 may be accommodated within the jelly roll case 100 (e.g., the hatched structure in FIG. 1). The jelly roll 10 with the tape 20 attached to the top surface thereof may be introduced into the jelly roll case 100. The jelly roll 10 may be introduced into the open top surface of the jelly roll case 100 and seated on (e.g., inside) the jelly roll case 100. The driver 300 may drive the jelly roll case 100 upward. The driver 300 may drive the jelly roll case 100, into which the jelly roll 10 is introduced, upward (e.g., toward the insertion jig 200).

The insertion jig 200 may be provided with a through-hole 201 coupled (e.g., couplable) to the top end of the jelly roll case 100 to guide the jelly roll 10. Referring to FIG. 1, the jelly roll case 100 may be moved (e.g., movable) upward by the driver 300 (e.g., along the arrow), and the jelly roll 10 seated in the jelly roll case 100 may be directed toward the through-hole 201 of the insertion jig 200.

Referring to FIG. 2, the insertion jig 200 may include a base 210, a tapered portion 220, a first stepped portion 230, and a second stepped portion 240. For example, referring to FIG. 2, the insertion jig 200 may include an outer sidewall structure (e.g., the hatched section in FIG. 2) defined by the first stepped portion 230, the tapered portion 220, the base 210, and the second stepped portion 240 stacked vertically and integrally (e.g., formed of a same material and in a same process as a monolithic and seamless structure) on top of each other, with the through-hole 201 extending continuously through the entire sidewall structure along a vertical direction. For example, the outer sidewall structure may surround an entire perimeter of the through-hole 201 (e.g., in a top view), and a thickness of the outer sidewall structure may vary along a radial direction of the through-hole 201 (e.g., each of the base 210, the tapered portion 220, the first stepped portion 230, and the second stepped portion 240 may have a different thickness along the radial direction of the through-hole 201, as measured from an outermost surface of the outer sidewall structure.

The base 210 may be provided on (e.g., to define) the inner surface of the through-hole 201. The tapered portion 220 may be provided on the inner surface of the through-hole 201 at the bottom end of the base 210. The tapered portion 220 may have a slope and extend to the bottom end of the base 210. For example, referring to FIG. 2, the inner surface of the base 210 facing the through-hole 201 may define (e.g., surround) the through-hole 201.

The first stepped portion 230 may be provided on the inner surface of the through-hole 201 at the bottom end of the tapered portion 220 (e.g., the tapered portion 220 may be directly between the first stepped portion 230 and the base 210). The first stepped portion 230 may be provided by recessing at a right angle into the inner surface of the through-hole 201 at the bottom end of the tapered portion 220 (e.g., a thickness of the first stepped portion 230 in the radial direction of the through-hole 201 may be smaller than a thickness of the tapered portion 220 in the radial direction of the through-hole 201 to define a step between the first stepped portion 230 and the tapered portion 220). The first stepped portion 230 may be coupled to the top end of the jelly roll case 100. The tapered portion 220 may decrease in radial size (e.g., width) from the first stepped portion 230 toward the base 210 (e.g., a cross-section of the portion of the through-hole 201 in the tapered portion 220 may have a trapezoidal cross-section in a side view).

The second stepped portion 240 may be provided on the inner surface of the through-hole 201 in the top end of the tapered portion 220 (e.g., the base 210 may be directly between the second stepped portion 240 and the tapered portion 220). The second stepped portion 240 may be provided by recessing at a right angle into the inner surface of the through-hole 201 in the top end of the tapered portion 220 (e.g., a thickness of the second stepped portion 240 in the radial direction of the through-hole 201 may be smaller than a thickness of the base 210 in the radial direction of the through-hole 201 to define a step between the second stepped portion 240 and the base 210).

In the present disclosure, the secondary battery may be a cylindrical secondary battery. For example, referring to FIG. 3, the cylindrical secondary battery may have the shape of a column. The jelly roll 10 may include a first electrode, a second electrode, and a separator. The jelly roll 10 may be configured by winding the first electrode, the second electrode, and the separator provided between the first electrode and the second electrode. The jelly roll 10 may be wound to form a winding core, and may have a through-hole in the winding core.

The tape 20 may be a material having insulating properties. In an embodiment, the tape 20 may include a polymeric plastic formed from, e.g., polypropylene (PP), polyethylene terephthalate (PET), or polyimide (PI).

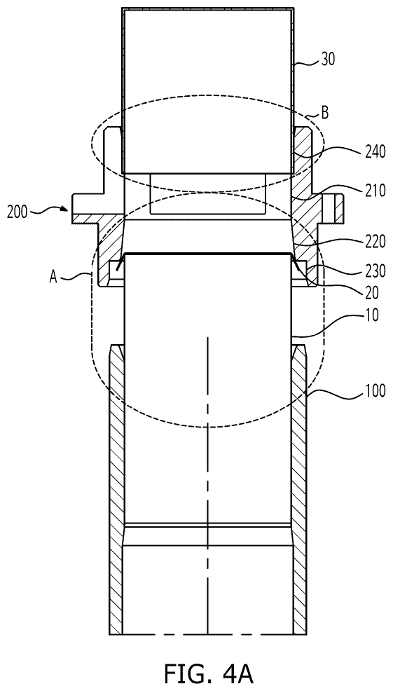

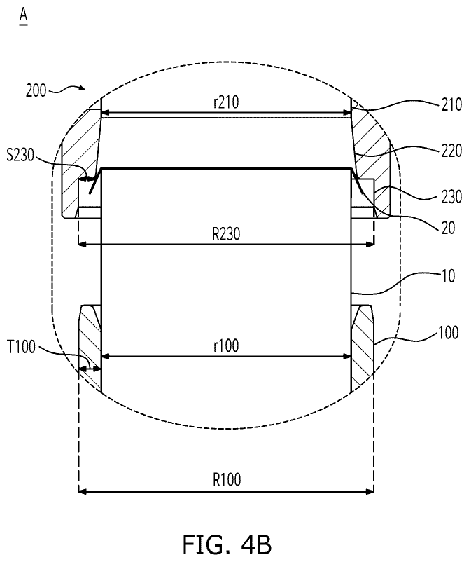

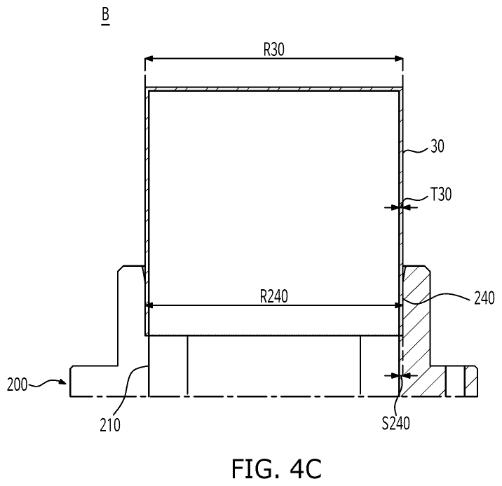

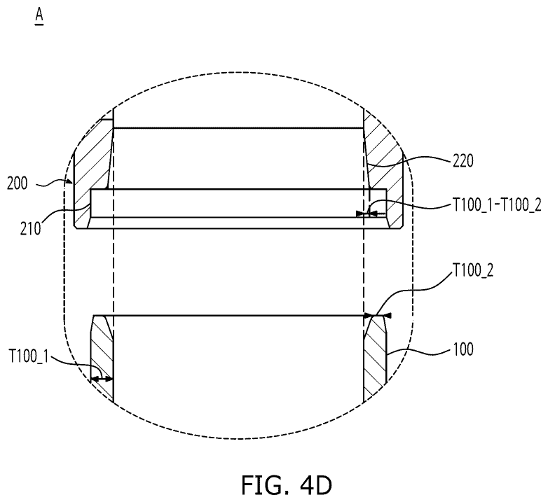

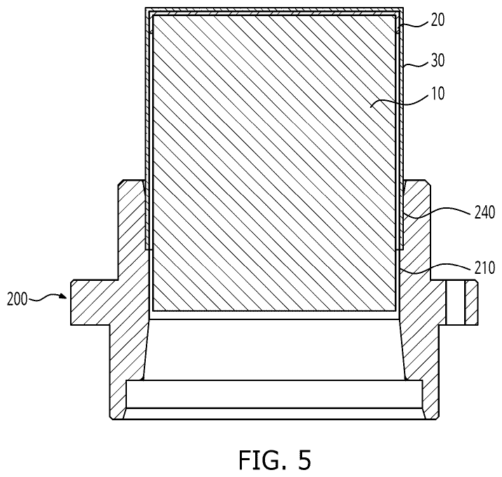

FIG. 4A illustrates a cross-sectional view showing the jelly roll 10 in FIG. 3 introduced into the insulation taping device for a secondary battery according to embodiments of the present disclosure, FIG. 4B illustrates an enlarged view showing region A of FIG. 4A, FIG. 4C illustrates an enlarged view showing region B of FIG. 4A, FIG. 4D illustrates an enlarged view showing region A in which the jelly roll and the tape are omitted, and FIG. 5 illustrates the jelly roll inserted up to the terminal end of a can coupled to the insertion jig 200 according to embodiments of the present disclosure.

Referring to FIG. 4A, the jelly roll 10 with the tape 20 may be seated in the jelly roll case 100, and the jelly roll 10 with the tape 20 may protrude above the sidewall of the jelly roll case 100. The jelly roll case 100 with the jelly roll 10 therein may be moved toward the bottom of the insertion jig 200 by the driver 300 (FIG. 1), while the top of the insertion jig 200 may be coupled to a bottom end of a can 30. When the tape 20 on the jelly roll 10 contacts (e.g., is inserted through) the bottom of the through-hole 201 of the insertion jig 200 (e.g., when the jelly roll 10 with the tape 20 are inserted sequentially through the first stepped portion 230, the tapered portion 220, and the base 210), the tape 20 may be pushed toward and adhered to side surfaces of the jelly roll 10 (e.g., by the inner surfaces of the tapered portion 220 and the base 210), as the jelly roll 10 is inserted into the can 30. The insertion jig 200 may include the second stepped portion 240 provided on the inner surface of the through-hole 201 in the top end of the tapered portion 220 to which the can 30 is coupled.

The can 30 may accommodate the jelly roll 10 and an electrolyte (e.g., an electrolyte solution), and together with the cap assembly, may form the contour of a secondary battery. The can 30 may be provided in a columnar shape to accommodate the jelly roll 10. The jelly roll 10 may be inserted through an open area provided in one side of the can 30. Thereafter, the open area of the can 30 may be sealed by the cap assembly.

The first stepped portion 230 may be configured such that the terminal end of the jelly roll case 100 is inserted therein (e.g., the terminal end of the jelly roll case 100 may be fitted to be flush against and directly contact a flat bottom of the tapered portion 220 and an inner sidewall the first stepped portion 230). The second stepped portion 240 may be configured such that the terminal end of the can 30 is inserted therein (e.g., the terminal end of the can 30 may be fitted to be flush against and directly contact a flat top of the base 210 and an inner sidewall the second stepped portion 240). The can 30 and the jelly roll case 100, which are positioned above and below the insertion jig 200, respectively, may be inserted into the insertion jig 200 such that the center axis lines of the can 30 and the jelly roll 10 are aligned (e.g., are colinear). Thus, the jelly roll 10, which is pushed up from a spindle positioned under the jelly roll 10, may be aligned with the center axis line of the can 30. Accordingly, the jelly roll 10 may be safely inserted into the can 30 supported in an upright state, and the secondary battery may be prevented from having poor quality or deterioration due to damage that would otherwise be caused by hitting the opening of the can 30.

In an embodiment, referring to FIG. 4B, the diameter R230 of the first stepped portion 230 may correspond to (e.g., may equal) the outer diameter R100 of the jelly roll case 100. A width of the step S230 of the first stepped portion 230 may be formed smaller than the thickness T100 of the sidewall of the jelly roll case 100 (e.g., in the radial direction of the through-hole 201). The inner diameter r100 of the jelly roll case 100 may correspond to (e.g., may equal) the inner diameter r210 of the base 210.

Referring to FIG. 4C, the diameter R240 of the second stepped portion 240 may correspond to (e.g., may equal) the outer diameter R30 of the can 30. For example, a width of the step S240 of the second stepped portion 240 may correspond to the thickness T30 of a sidewall of the can 30 (e.g., in the radial direction of the through-hole 201).

Accordingly, the jelly roll 10 and the tape 20 may be safely inserted into the can 30 without being stamped or bumped during upward movement through the insertion jig 200 and into the can 30.

For example, the inner diameter R210 of the base 210 may correspond to the jelly roll 10 to which the tape 20 is adhered. For example, in a case where the diameter of the jelly roll 10 is 44.85 mm and the thickness of the tape 20 is 0.043 mm (on each side of the jelly roll 10), the maximum diameter of the jelly roll 10 with the tape 20 may be 44.936 mm. In this case, the inner diameter r210 of the base 210 may be 44.936 mm.

As the jelly roll 10 moves upward and the tape 20 contacts the inner circumferential surface of the base 210, the outer peripheral portion of the tape 20 may circumferentially adhere to the outer surface of the jelly roll 10. That is, in response to the upward movement of the jelly roll 10, the tape 20 may be bent by contact with the tapered portion 220. As the jelly roll 10 subsequently moves upward and the tape 20 contacts the inner surface of the base 210, the tape 20 may fully adhere to the outer surface of the jelly roll 10. Accordingly, the tape 20 may be uniformly bent and uniformly adhere to the outer circumferential surface of the jelly roll 10, and defects such as non-adherence to the side surfaces of the jelly roll 10 or defects caused by overlapping between the tapes 20 may be prevented.

For example, referring to FIG. 4D, the bottom end of the tapered portion 220 may be tapered by a difference T100_1-T100_2 between the maximum thickness T100_1 and the minimum thickness T100_2 of the jelly roll case 100. In an example, the outer diameter of the top end of the tapered portion 220 may be greater than the outer diameter of the jelly roll 10 by 0.05 mm. For example, in a case where the outer diameter of the jelly roll 10 is 44.85 mm, the outer diameter of the top end of the tapered portion 220 may be 44.90 mm.

The outer diameter of the bottom end of the tapered portion 220 may be set smaller than the outer diameter of the tape 20. Accordingly, the tape 20 may be bent by contact with the tapered portion 220 in response to the upward movement of the jelly roll 10.

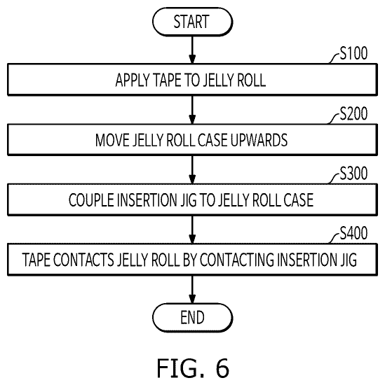

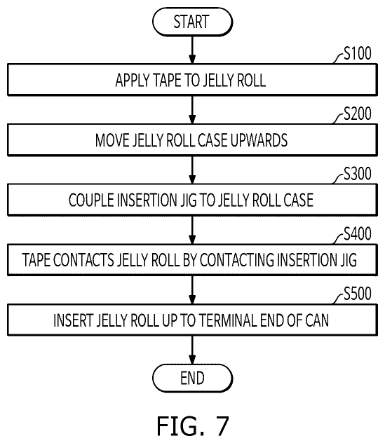

FIG. 6 illustrates a flowchart showing an insulation taping method for a secondary battery according to embodiments of the present disclosure, and FIG. 7 illustrates a flowchart showing an insulation taping method for a secondary battery in which a jelly roll inserting operation is added according to embodiments of the present disclosure.

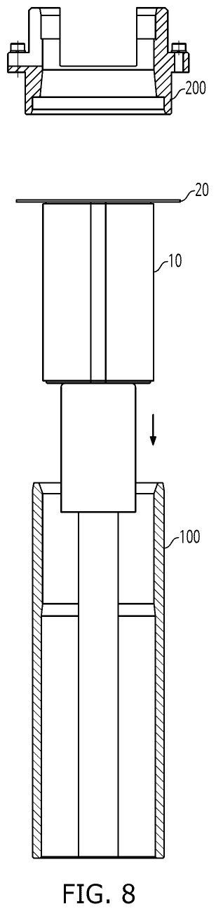

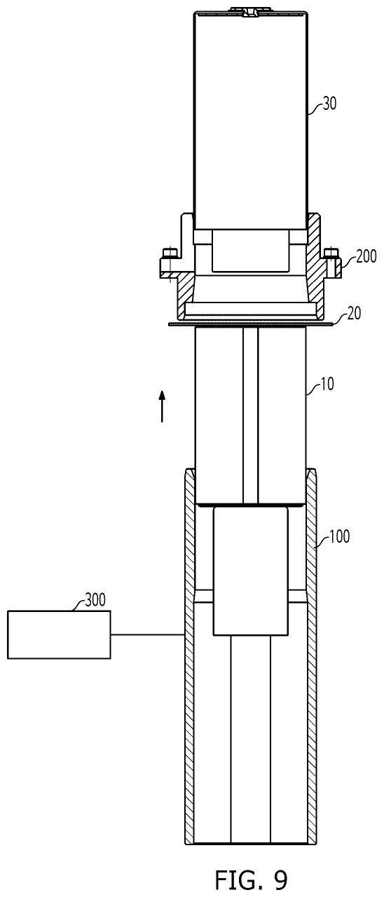

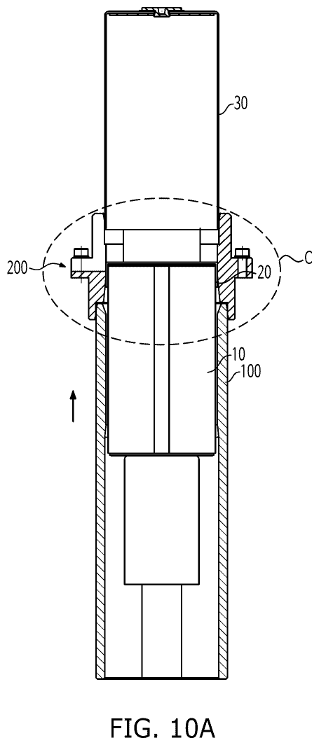

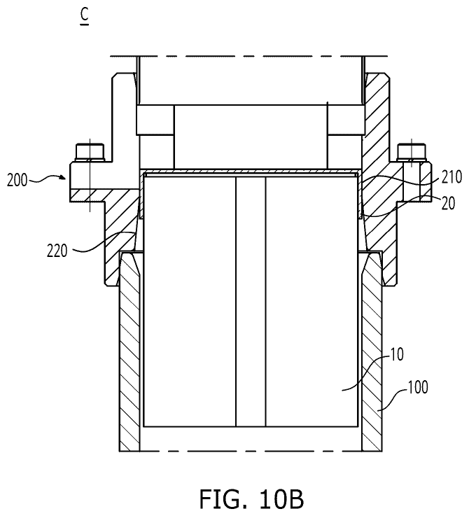

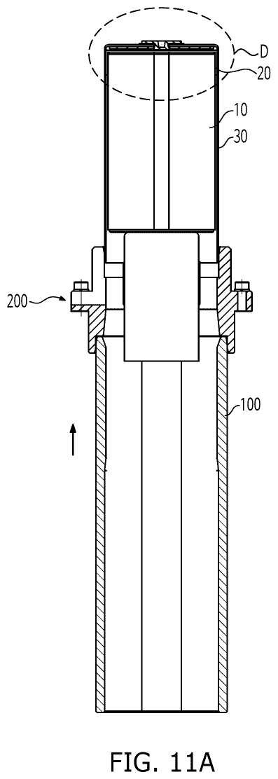

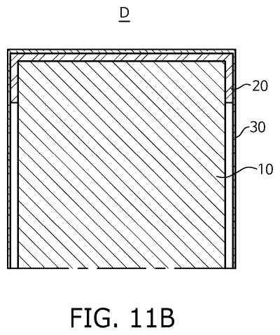

FIG. 8 illustrates a process of the insulation taping method for a secondary battery according to embodiments of the present disclosure, FIG. 9 illustrates a process of the insulation taping method for a secondary battery according to embodiments of the present disclosure, following the process of FIG. 8, FIG. 10A illustrates a process of the insulation taping method for a secondary battery according to embodiments of the present disclosure, following the process of FIG. 9, FIG. 10B illustrates an enlarged view showing area C of FIG. 10A FIG. 11A illustrates a process of the insulation taping method for a secondary battery according to embodiments of the present disclosure, following the process of FIG. 10A, and FIG. 11B illustrates an enlarged view showing area D of FIG. 11A.

Referring to FIG. 6, in an embodiment, the insulation taping method for a secondary battery may include an operation S100 of applying tape to the top surface of a jelly roll, an operation S200 of moving, by a driver, a jelly roll case upward into which a jelly roll is inserted, an operation S300 of coupling an insertion jig to the jelly roll case, the insertion jig having a through-hole configured to guide the jelly roll, and an operation S400 of pressing the tape to the upper portion of the jelly roll as the jelly roll is inserted into the can to which the insertion jig is coupled. According to an embodiment of the present disclosure, as illustrated in FIG. 7, the insulation taping method may further include an operation S500 of inserting the jelly roll up to the terminal end of the can.

The operation S200 of moving the jelly roll case upward may include an operation of introducing the jelly roll 10, to which the tape 20 is attached, into the opened top surface of the jelly roll case 100. As shown in FIG. 8, in the operation of introducing the jelly roll 10, to which the tape 20 is attached, into the opened top surface of the jelly roll case 100, the jelly roll 10 may be introduced into the opened top surface of the jelly roll case 100 and seated on the jelly roll case 100. The driver 300 may drive the jelly roll case 100 upward into which the jelly roll 10 is introduced.

In the operation S300 of coupling the insertion jig to the jelly roll case, the terminal end of the jelly roll case 100 may be inserted into the first stepped portion provided on the inner surface of the through-hole. In the operation S300 of coupling the insertion jig to the jelly roll case, the jelly roll case 100 may be moved upward by the driver 300, as shown in FIG. 9, and the jelly roll 10 may be directed toward the through-hole of the insertion jig 200.

The operation S300 of coupling the insertion jig to the jelly roll case may include an operation of bending the outer peripheral portion of the tape 20 by contact with the tapered portion 220 provided on the inner surface of the through-hole. In the operation S400 of compressing (i.e., pressing or bending) the tape, in a case where the jelly roll 10 is moved upward to be inserted into the can 30, the outer portion of the tape 20 may circumferentially adhere to the outer surface of the jelly roll 10.

In operation S300 of coupling the insertion jig to the jelly roll case, the tape 20 may be bent while contacting the tapered portion 220 of the insertion jig 200. The tapered portion 220 may be formed by extending at a slope to the bottom end of the base 210.

As shown in FIGS. 10A and 10B, in the operation S400 of compressing the tape, the jelly roll 10 may move upward and the tape 20 may contact the inner circumferential surface of the base 210, so that the outer peripheral portion of the tape 20 may adhere circumferentially to the outer surface of the jelly roll 10. That is, as the jelly roll 10 is raised, the tape 20 is bent by contacting the tapered portion 220, and as the jelly roll 10 is subsequently raised, the tape 20 can be fully adhered to the outer surface of the jelly roll 10 by contacting the inner surface of the base 210. Accordingly, the tape 20 may be uniformly bent to uniformly adhere to the outer circumferential surface of the jelly roll 10, and defects such as non-adherence to the side surfaces of the jelly roll 10 or defects caused by overlapping between the tapes 20 may be prevented.

In the operation S500 of inserting the jelly roll, the jelly roll 10, which is insulated by the tape 20 on the top surface, may be moved upward without interference with the inner circumferential surface of the can 30. Here, the jelly roll 10 may be inserted through the open area provided in one side of the can 30.

As shown in FIG. 11A and FIG. 11B, the jelly roll 10 may be moved upward toward the terminal end of the can 30 with the tape 20 uniformly bent and uniformly adhered to the outer circumferential surface of the jelly roll 10. Accordingly, defects caused by non-adherence to the sides of the jelly roll 10 or overlap between the tapes 20 may be prevented.

By way of summation and review, when inserting a jelly roll electrode assembly into a can, the electrode assembly may be inserted into the can after an insulating tape is pressed along the outer diameter of the jelly roll (i.e., a jelly roll electrode assembly), in a state where the insulating tape is already attached to the upper portion of the jelly roll. However, a partial defect in which the insulating tape is not properly attached to a side surface of the jelly roll may occur, and in a case where the side surface is further compressed to reduce the defect, an outer portion of the jelly roll may be compressed, thereby potentially causing short circuits.

In contrast, the present disclosure provides an insulation taping device for a secondary battery and an insulation taping method for a secondary battery that improve insulating tape adhesion to the jelly roll. That is, the present disclosure provides an insulation taping device that bends and adheres an insulating tape along the outer diameter of the jelly roll, while the jelly roll is being inserted into the can.

According to various embodiments of the present disclosure, a tape may be bent by contact with the tapered portion of an insertion jig, and then the tape may adhere completely to the outer circumferential surface of the jelly roll, as the jelly roll is subsequently moved toward the can. Accordingly, the tape may be prevented from failing to adhere to side surfaces of the jelly roll.

According to various embodiments of the present disclosure, in the process of coupling the jelly roll case to the insertion jig, the tape may be bent by contact with the tapered portion of the insertion jig, and the tape may be adhered subsequently to the outer circumferential surface of the jelly roll in the process in which the jelly roll is inserted into the can. Accordingly, the process may be simplified, e.g., compared to a process of pressing an insulating tape to the top surface of the jelly roll before inserting the jelly roll into the can.

According to various embodiments of the present disclosure, the first stepped portion of the insertion jig and the jelly roll case may be fitted and the second stepped portion of the insert jig and the can (i.e., to accommodate the jelly roll) may be fitted so that the jelly roll may be moved toward the can while maintaining the central axis during insertion into the can. Accordingly, the jelly roll may be prevented from having poor quality or deterioration due to damage that would otherwise be caused by hitting the opening of the can during the insertion of the jelly roll into the can.

However, aspects and features of the present disclosure are not limited to those described above, and other aspects and features not mentioned will be clearly understood by a person skilled in the art from the detailed description, described above.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An insulation taping device for a secondary battery, the insulation taping device comprising:
a jelly roll case, into which a jelly roll with a tape attached to a top surface of the jelly roll is to be introduced;
an insertion jig including a through-hole and positioned above the jelly roll case, the insertion jig being configured to be coupled to a bottom end of a can, and the through-hole being configured to be coupled to a top end of the jelly roll case to guide the jelly roll; and
a driver configured to drive the jelly roll case into the insertion jig, the tape on the top surface of the jelly roll contacting the insertion jig and adhering to a side surface of the jelly roll as the jelly roll is inserted into the can in the insertion jig.

2. The insulation taping device as claimed in claim 1, wherein the insertion jig includes:
a base on an inner surface of the through-hole;
a tapered portion on the inner surface of the through-hole at a bottom end of the base;
a first stepped portion on the inner surface of the through-hole at a bottom end of the tapered portion, the first stepped portion being couplable to the top end of the jelly roll case; and
a second stepped portion on the inner surface of the through-hole at a top end of the tapered portion, the second stepped portion being couplable to the can.

3. The insulation taping device as claimed in claim 2, wherein a radial size of the tapered portion decreases from the first stepped portion toward the base.

4. The insulation taping device as claimed in claim 2, wherein a diameter of the first stepped portion corresponds to an outer diameter of the jelly roll case.

5. The insulation taping device as claimed in claim 2, wherein a width of a step of the first stepped portion is smaller than a thickness of the jelly roll case.

6. The insulation taping device as claimed in claim 2, wherein an inner diameter of the jelly roll case corresponds to an inner diameter of the base.

7. The insulation taping device as claimed in claim 2, wherein a diameter of the second stepped portion corresponds to an outer diameter of the can.

8. The insulation taping device as claimed in claim 2, wherein a width of a step of the second stepped portion corresponds to a thickness of the can.

9. The insulation taping device as claimed in claim 2, wherein the first stepped portion is configured such that a terminal end of the jelly roll case is inserted thereinto.

10. The insulation taping device as claimed in claim 2, wherein an inner diameter of the base corresponds to the jelly roll to which the tape is adhered.

11. The insulation taping device as claimed in claim 10, wherein an outer peripheral portion of the tape is circumferentially adhered to an outer surface of the jelly roll as the tape contacts an inner circumferential surface of the base due to upward movement of the jelly roll.

12. The insulation taping device as claimed in claim 2, wherein the tapered portion is tapered at the bottom end of the base by a difference between a maximum thickness and a minimum thickness of the jelly roll case.

13. The insulation taping device as claimed in claim 2, wherein the second stepped portion is configured to receive a terminal end of the can.

14. An insulation taping method for a secondary battery, the insulation taping method comprising:
attaching a tape to a top surface of a jelly roll;
inserting the jelly roll with the tape into a jelly roll case;
moving, by a driver, the jelly roll case upward toward an insertion jig;
coupling the insertion jig to the jelly roll case, the insertion jig having a through-hole configured to guide the jelly roll; and
compressing the tape to an upper portion of the jelly roll as the jelly roll is inserted into a can to which the insertion jig is coupled.

15. The insulation taping method as claimed in claim 14, further comprising inserting the jelly roll up to a terminal end of the can.

16. The insulation taping method as claimed in claim 14, wherein moving the jelly roll case upward includes introducing the jelly roll, to which the tape is attached, into an opened top surface of the jelly roll case.

17. The insulation taping method as claimed in claim 14, wherein coupling the insertion jig to the jelly roll case includes inserting a terminal end of the jelly roll case into a first stepped portion provided on an inner surface of the through-hole.

18. The insulation taping method as claimed in claim 14, wherein coupling the insertion jig to the jelly roll case includes bending an outer peripheral portion of the tape by contact with a tapered portion provided on an inner surface of the through-hole.

19. The insulation taping method as claimed in claim 18, wherein compressing the tape includes circumferentially adhering the outer peripheral portion of the tape to an outer surface of the jelly roll, when the jelly roll is moved upward to be inserted into the can.

20. The insulation taping method as claimed in claim 14, wherein inserting the jelly roll includes moving the jelly roll, which is insulated by the tape on the top surface, upward without interference with an inner circumferential surface of the can.
